(19) United States
(12) Patent Application Publication
(10) Pub. No.: US 2018/0191010 A1
(43) Pub. Date: Jul. 5, 2018

(54) PROTECTION CIRCUIT FOR A FUEL CELL AND METHOD OF USE

(71) Applicant: General Electric Company, Schenectady, NY (US)

(72) Inventors: Patrick Hammel Hart, Niskayuna, NY (US); Ralph Teichmann, Malta, NY (US)

(21) Appl. No.: 15/397,422

(22) Filed: Jan. 3, 2017

(51) Int. Cl. H01M 8/04828; H01M 8/04537; H01M 8/04858

(52) U.S. Cl. CPC H01M 8/04947; H01M 8/04932; H01M 8/04611

(57) ABSTRACT

A protection circuit for a fuel cell coupled to a load. The protection circuit includes a switch and a controller. The switch is coupled between the fuel cell and an auxiliary load. The switch is configured to selectively couple the auxiliary load to the fuel cell. The controller is coupled to the switch. The controller is configured to control the switch to couple the auxiliary load to the fuel cell when the load demands a reduction in power output from the fuel cell. The controller is further configured to maintain the power output from said fuel cell at an initial level.

### BACKGROUND

The field of the disclosure relates generally to fuel cells and, more particularly, to a protection circuit for controlling output power of fuel cells while transitioning between output power levels.

Many known electrical systems utilize one or more power sources to provide the necessary power to operate various electrical equipment. The electrical load on the power sources may vary over time and, under certain circumstances, may increase or decrease rapidly during a transient event or a planned ramp-up or ramp down of power output. Many known electrical systems, such as, for example, and without limitation, those that connect to an electrical grid, are required to transition between power levels within a certain amount of time. Some known electrical systems utilize power sources, such as, for example, and without limitation, batteries, that can ramp-up and ramp-down power output, i.e., transition between power levels, rapidly to satisfy the power demand of the load. Some known electrical systems utilize energy storage systems to store excess power when rapidly ramping-down power output and to supply excess power when rapidly ramping-up power output.

Many known electrical systems utilize fuel cells. Fuel cells generate power output via a chemical process that converts a chemical fuel, such as, for example, hydrogen, into electrical energy. Fuel cells are generally slow at transitioning between power levels. Fuel cells are particularly sensitive to sustained ramping-up and ramping-down, in that the rapid transition within the chemical process may have damaging effects on the fuel cells themselves. During a transient event or a planned ramp-up or ramp-down of power output, such electrical systems typically rely on energy storage systems, such as, for example, and without limitation, batteries, to provide relief. However, energy storage systems are expensive and the duration of relief provided by energy storage systems is limited by size and cost.

### BRIEF DESCRIPTION

In one aspect, a protection circuit for a fuel cell coupled to a load is provided. The protection circuit includes a switch and a controller. The switch is coupled between the fuel cell and an auxiliary load. The switch is configured to selectively couple the auxiliary load to the fuel cell. The controller is coupled to the switch. The controller is configured to control the switch to couple the auxiliary load to the fuel cell when the load demands a reduction in power output from the fuel cell. The controller is further configured to maintain the power output from said fuel cell at an initial level.

In another aspect, an electrical system is provided. The electrical system includes a fuel cell, an inverter, and a protection circuit. The fuel cell is configured to generate an output power according to a chemical process. The inverter is coupled to the fuel cell and an electric load. The inverter is configured to demand the output power from the fuel cell for the electric load. The protection circuit is coupled to the fuel cell and the inverter. The protection circuit is configured to detect a reduction in the output power demanded by the inverter. The protection circuit is further configured to control an auxiliary load coupled to the fuel cell to utilize the output power at an initial level. The protection circuit is further configured to maintain the power output from the fuel cell at the initial level.

In yet another aspect, a method of controlling an output power of a fuel cell is provided. The method includes controlling a chemical process of the fuel cell to generate the output power at an initial level demanded by a load coupled to the fuel cell. The method includes determining a reduction in power demanded by the load. The method includes controlling an auxiliary load coupled to the fuel cell to utilize the reduction in power demanded by the load. The method includes maintaining the output power from the fuel cell at the initial level.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary electrical system;

FIG. 2 is a schematic diagram of the electrical system shown in FIG. 1;

FIG. 3 is a plot of an exemplary power curve for a fuel cell for use in the electrical system shown in FIGS. 1 and 2;

FIG. 4 is a plot of an exemplary power curve for an auxiliary load for use in the electrical system shown in FIGS. 1 and 2;

FIG. 5 is a plot of an exemplary power curve for a load for use in the electrical system shown in FIGS. 1 and 2; and

FIG. 6 is a flow diagram of an exemplary method of controlling output power of a fuel cell using the electrical system shown in FIGS. 1 and 2.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, a number of terms are referenced that have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the terms processor, processing device, and controller.

In the embodiments described herein, memory may include, but is not limited to, a computer-readable medium, such as a random access memory (RAM), and a computer-readable non-volatile medium, such as flash memory. Alternatively, a floppy disk, a compact disc—read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Embodiments of the present disclosure provide a protection circuit for a fuel cell. More specifically, embodiments of the present disclosure describe a protection circuit for controlling power output of a fuel cell during a transition between power levels. Embodiments of the present disclosure facilitate operation of a fuel cell within healthy operating boundaries for the fuel cell's chemical process through transitions between power levels. For example, protection circuits described herein maintain a relatively constant power output for the fuel cell during a rapid change in load, which may occur, for example, and without limitation, during a transient event, a planned ramp-up in output power, and a planned ramp-down in output power. In such embodiments, total power delivered to the load varies according to these events, but fuel cell power output remains relatively constant. Protection circuits described herein control an auxiliary load coupled to the fuel cell during such events to utilize the excess power output from the fuel cell. The auxiliary load may include, for example, and without limitation, load banks, electric heaters, electric steam generators, and other electrical loads.

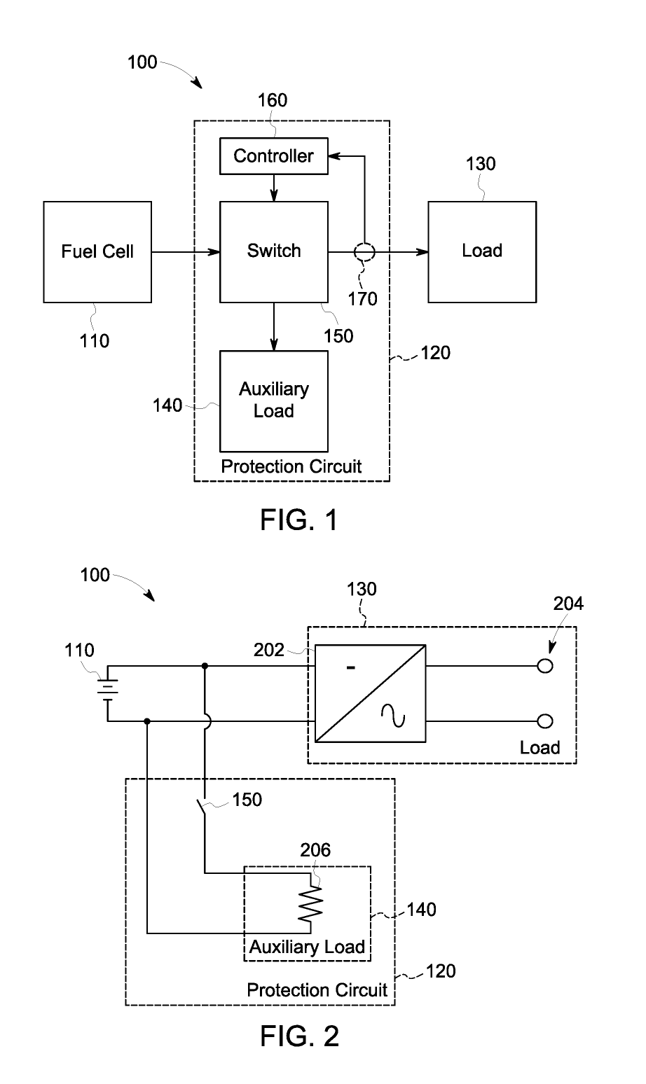

FIG. 1 is a block diagram of an exemplary electrical system 100. Electrical system 100 includes a fuel cell 110, a protection circuit 120, and a load 130. Fuel cell 110 provides power to load 130 through protection circuit 120. In certain embodiments, for example, and without limitation, electrical system 100 may include multiple fuel cells for powering load 130. In certain embodiments, the multiple fuel cells may power multiple loads, including load 130. Protection circuit 120 includes an auxiliary load 140 that is selectively coupled to fuel cell 110 by a switch 150. Switch 150 is coupled to a controller 160 that controls operation of protection circuit 120 to control power output of fuel cell 110. Controller 160, in certain embodiments, includes a processor programmed to control a network of switches within switch 150 to connect an appropriate load within auxiliary load 140 to fuel cell 110 to utilize excess power generated when load 130 ramps down. Load 130 is a time varying load and may exhibit planned or intentional, ramp-up or ramp-down in demanded power from fuel cell 110. Load 130 may further experience unplanned, or transient events, such as, for example, and without limitation, short circuits, over-voltage events, and over-frequency events. Such transitions in power level may demand ramp-up or ramp-down of power output from fuel cell 110 that exceed a ramp-rate limit of fuel cell 110 and its ongoing chemical processes that generate the output power. Controller 160, in certain embodiments, controls protection circuit 120 based on a measured current, voltage, or power from a sensor 170.

Fuel cell 110 may include a high-temperature fuel cell system that utilizes electric heaters and electric steam generation to initiate operation. During “steady-state” operation, such components are typically power-off. Protection circuit 120, in certain embodiments, is configured to utilize such electric heaters and electric steam generators as auxiliary load 140 to further manage the chemical process conditions for fuel cell 110, including, for example, and without limitation, temperature and steam-to-carbon ratio, during a transition between power levels. More specifically, for example, a transient event for load 130 may result in a sudden disconnection of load 130 from fuel cell 110. Rather than rapidly ramping down the chemical process of fuel cell 110, protection circuit 120 selectively couples auxiliary load 140 to fuel cell 110 through switch 150, thus preventing alternating of chemical process conditions that can damage fuel cell 110. For example, ramping-down of output power from fuel cell 110 may reduce the water production, which impacts the steam-to-carbon ratio. The chemical process conditions for fuel cell 110 define the ramp-rate limit that fuel cell 110 can support during transitions between power levels. Controller 160, given the ramp-rate limit for fuel cell 110, determines whether a transition between power levels can be achieved, within the ramp-rate limit, or requires auxiliary load 140 to be attached. If the transition is achievable by fuel cell 110, controller 160, in certain embodiments, modifies the chemical process of fuel cell 110 to ramp-up or ramp-down the power output. If the transition exceeds the ramp-rate limit, controller 160 determines which components of auxiliary load 140 should be coupled or decoupled to fuel cell 110 to sink a sufficient amount of output power from fuel cell 110 to facilitate a relatively constant power output from fuel cell 110. In certain embodiments, controller 160 controls switch 150 using a pulse-width modulation (PWM) or pulse density modulation signal to continuously regulate power flow to auxiliary load 140. Auxiliary load 140 may include variable load components such as, for example, and without limitation, load banks, electric heaters, and electric steam generators. Such auxiliary loads 140 generally affect the operation of fuel cell 110. In certain embodiments, auxiliary loads 140 may include components supporting other fuel cells or other power plants that supply power to load 130.

FIG. 2 is a schematic diagram of electrical system 100 (shown in FIG. 1). Electrical system 100 includes fuel cell 110, protection circuit 120, and load 130 (shown in FIG. 1). Load 130 includes an inverter 202 coupled between protection circuit 120 and an output stage 204. Inverter 202 is configured to convert a direct current (DC) output voltage generated by fuel cell 110 to an alternating current (AC) output voltage to be provided at output stage 204. Inverter 202 operates with variable efficiency as a function of input voltage, output current, and switching frequency, for example, and without limitation. Output stage 204 is configured to be coupled to electrical equipment, an AC bus, or any other suitable AC or DC load. Inverter 202, under certain circumstances, may disconnect output stage 204 from fuel cell 110. For example, and without limitation, inverter 202 may disconnect output stage 204 during a transient event, resulting in a ramping-down of load 130 on fuel cell 110. During such an event, protection circuit 120 closes switch 150 to couple auxiliary load 140 to fuel cell 110 to utilize the excess power output from fuel cell 110. The output power from fuel cell 110 remains constant relative to load 130.

Protection circuit 120 includes switch 150 coupled in series between fuel cell 110 and auxiliary load 140. Switch 150 may be implemented as, for example, and without limitation, an electro-mechanical contactor, a relay, a solid-state contactor, semiconductor switch, or other suitable electrical switch for opening and closing the circuit between fuel cell 110 and auxiliary load 140. Switch 150 is controlled by a control signal transmitted from controller 160 (shown in FIG. 1). In some embodiments, switch 150 is normally open and is commutated to a closed position when the control signal provides a sufficient voltage. In alternative embodiments, switch 150 may be embodied by a normally closed switch. Switch 150 is controlled, for example, and without limitation, based on an output voltage from fuel cell 110 to be provided to load 130. Alternatively, switch 150 is controlled based on power demanded by load 130.

Auxiliary load 140 includes an impedance 206 that may be implemented as simple resistance or any other suitable load for sinking current from fuel cell 110. For example, and without limitation, impedance 206 may include electric heaters and electric steam generators to support the chemical process of fuel cell 110.

During operation of protection circuit 120, when load 130 reduces rapidly, i.e., is transitioning to a lower power level, controller 160 compares the reduction to the ramp-rate limit for fuel cell 110. When the reduction exceeds the ramp-rate limit, switch 150 is closed and auxiliary load 140 is coupled to fuel cell 110. Auxiliary load 140 utilizes excess power output from fuel cell 110 that would otherwise be supplied to load 130. The power output from fuel cell 110 remains constant relative to load 130. For example, load 130 may be reduced 100% during a transient event, while the power output from fuel cell 110 fluctuates plus-or-minus 5%. The extent to which fuel cell 110 tolerates fluctuations in output power is a function of the precise chemical process of fuel cell 110 and the associated ramp-rate limit. When load 130 returns to its previous power level, for example, and without limitation, when a transient event clears, or when a planned ramp-up occurs, switch 150 is selectively opened to disconnect auxiliary load 140 and the power output from fuel cell 110 is directed to load 130.

In certain embodiments, auxiliary load 140 includes multiple components that may be prioritized in connecting to fuel cell 110. For example, and without limitation, auxiliary load 140 may include load banks that simply sink power output from fuel cell 110. Auxiliary load 140 may further include electric heaters or electric steam generators that regulate chemical process conditions for fuel cell 110. The load banks are wasteful relative to the electrical equipment that supports the chemical process of fuel cell 110. Accordingly, controller 160, in certain embodiments, may selectively couple the electric heaters and electric steam generators to utilize excess power from fuel cell 110 before coupling a resistive load bank that simply sinks current and dissipates energy in the form of heat. In certain embodiments, controller 160 may adjust a variable load set point for auxiliary load 140 to adjust the amount of power consumed by auxiliary load 140. For example, and without limitation, controller 160 may initially operate a steam generator at 10% capacity. When the power demand of load 130 is reduced, controller 160 increases the load set point of the steam generator to utilize the excess power generated by fuel cell 110.

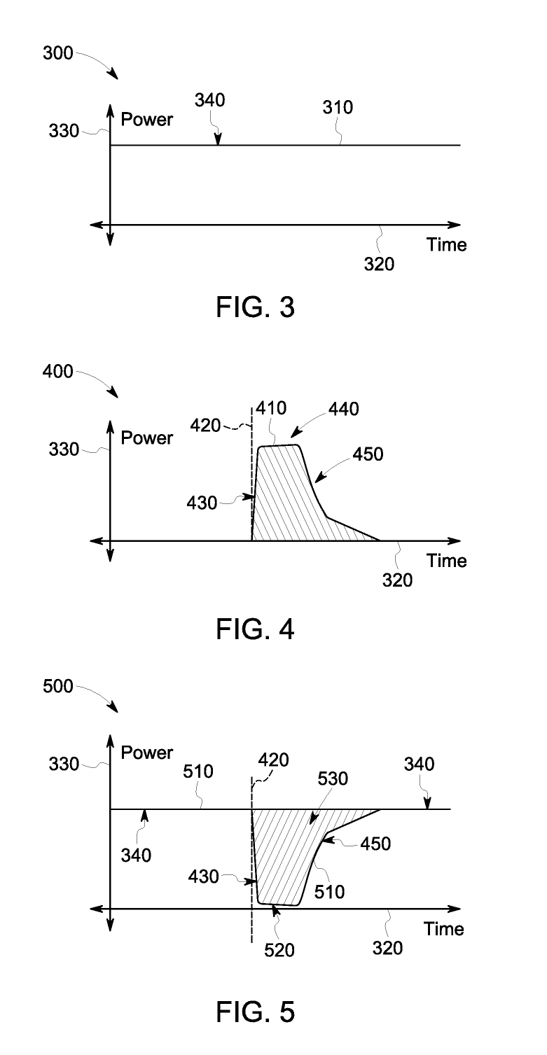

FIG. 3 is a plot 300 of a power output curve 310 for fuel cell 110 (shown in FIGS. 1 and 2). Plot 300 includes a horizontal axis representing time, referred to as a time axis 320. Time axis 320 is illustrated in seconds. Plot 300 also includes a vertical axis representing power, referred to as a power axis 330. Power axis 330 is illustrated in volt-amperes (VA). Power output curve 310 for fuel cell 110 is generally flat, representing a constant power output from fuel cell 110 over time. The power output by fuel cell 110 is referred to as an initial power level 340.

FIG. 4 is a plot 400 of a power demand curve 410 for auxiliary load 140 (shown in FIGS. 1 and 2). Plot 400 includes time axis 320, illustrated in seconds, and power axis 330, illustrated in Watts (shown in FIG. 3). Power demand curve 410 represents the power provided to auxiliary load 140 over time and, more specifically, power provided to auxiliary load 140 during a power level transition for load 130 from initial power level 340 to a lower power level, and then back to initial power level 340. Power demand curve 410 corresponds to the period of time illustrated in FIG. 3 for power output curve 310. During that period of time, in response to an event 420, load 130 transitions from initial power level 340 to a lower power level. Event 420 may be a transient event, such as, for example, and without limitation, an over-voltage event, an over-frequency event, or a short circuit. During such transient events, load 130 may be disconnected from fuel cell 110 by inverter 202. Event 420 may also be a planned transition from initial power level 340 to the lower power level. When event 420 occurs, load 130 is reduced and auxiliary load 140 is connected to fuel cell 110. Power demand curve 410 illustrates an initial transition 430 of power demanded by auxiliary load 140 from zero up to a steady-state power level 440. Auxiliary load 140 has a level demand through steady-state 440 until load 130 begins to ramp back up. When load 130 begins ramping up, power demand curve 410 illustrates a transition 450 of power demanded by auxiliary load 140 gradually down to zero again.

FIG. 5 is a plot 500 of a power output curve 510 to load 130 (shown in FIGS. 1 and 2). Plot 500 includes time axis 320, illustrated in seconds, and power axis 330, illustrated in Watts (shown in FIGS. 3 and 4). Power output curve 510 represents power provided to load 130 over time and, more specifically, power provided to load 130 by fuel cell 110 during a power level transition for load 130 from initial power level 340 to a lower power level 520, and then back to initial power level 340. Power output curve 510 corresponds to the period of time illustrated in FIGS. 3 and 4 for power output curve 310 and power demand curve 410.

Leading up to event 420, power output curve 510 illustrates load 130 having a generally flat demand at initial power level 340. When event 420 occurs, load 130 transitions 430 from initial power level 340 to lower power level 520. Transition 430 is illustrated by a dip in power output curve 510. The area above power output curve 510, illustrated by cross-hatching, represents power 530 provided to auxiliary load 140 over the duration of event 420. After a duration of time at lower power level 520, load 130 transitions 450 back up to initial power level 340.

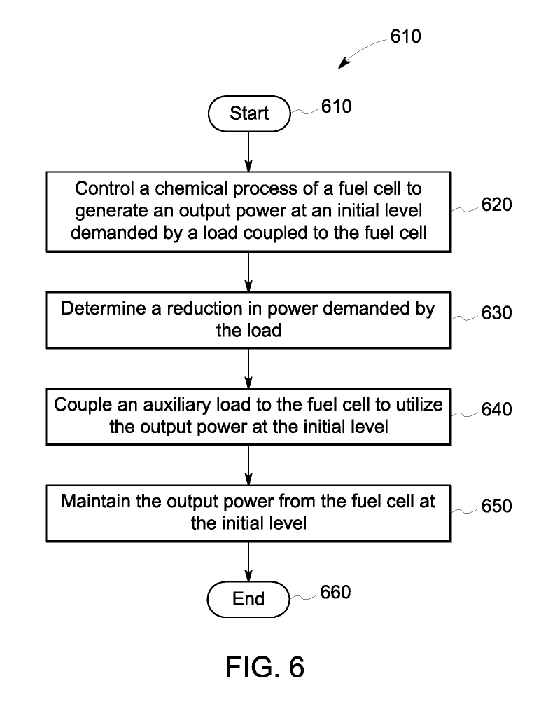

FIG. 6 is a flow diagram of an exemplary method 600 of controlling an output power of fuel cell 110 (shown in FIGS. 1 and 2). Method 600 begins at a start step 610. At a controlling step 620, controller 160 controls a chemical process for fuel cell 110 to generate output power at initial power level 340 demanded by load 130 coupled to fuel cell 110. Upon occurrence of event 420, controller 160 determines, at a determining step 630, a reduction in power demanded by load 130. The reduction in power is illustrated as transition 430 on power output curve 510. When the reduction in power exceeds the ramp-rate limit for fuel cell 110, controller 160 closes switch 150 at a coupling step 640. Upon closing, switch 150 couples auxiliary load 140 to fuel cell 110 to utilize the power output from fuel cell 110 at initial level 340. At a maintaining step 650, output power from fuel cell 110 is maintained at initial level 340, which is illustrated by power output curve 310. Method 600 terminates at an end step 660.

The above described embodiments of protection circuits for fuel cells provide a protection circuit for controlling power output of a fuel cell during a transition between power levels. Embodiments of the present disclosure facilitate operation of a fuel cell within rated operating boundaries for the fuel cell's chemical process through transitions between power levels. For example, protection circuits described herein maintain a relatively constant power output for the fuel cell during a rapid change in load, which may occur, for example, and without limitation, during a transient event, a planned ramp-up in output power, and a planned ramp-down in output power. In such embodiments, total power delivered to the load varies according to these events, but fuel cell power output remains relatively constant. Protection circuits described herein connect an auxiliary load during such events to utilize the excess power output from the fuel cell. The auxiliary load may include, for example, and without limitation, load banks, electric heaters, electric steam generators, and other electrical loads.

An exemplary technical effect of the methods, systems, and apparatus described herein includes at least one of: (a) maintaining operation of fuel cells within rated operating boundaries; (b) maintaining constant power output from fuel cells relative to a varying load; (c) protecting fuel cells from rapid ramping-up and ramping-down of power output; (d) reducing initial costs through installation of auxiliary loads versus energy storage systems; (e) reducing maintenance costs through use of auxiliary loads versus energy storage systems; (0 improving life expectancy of fuel cells through reduced stress during operation; and (g) improving system cost and reliability through reduced component count and component cost.

Exemplary embodiments of methods, systems, and apparatus for controlling output power of fuel cells are not limited to the specific embodiments described herein, but rather, components of systems and/or steps of the methods may be utilized independently and separately from other components and/or steps described herein. For example, the methods may also be used in combination with other non-conventional protection circuits for fuel cells, and are not limited to practice with only the systems and methods as described herein. Rather, the exemplary embodiment can be implemented and utilized in connection with many other applications, equipment, and systems that may benefit from increased efficiency, reduced operational cost, and reduced capital expenditure.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A protection circuit for a fuel cell coupled to a load, said protection circuit comprising:
a switch coupled between the fuel cell and an auxiliary load, said switch configured to selectively couple the auxiliary load to the fuel cell; and
a controller coupled to said switch, said controller configured to:
control said switch to couple the auxiliary load to the fuel cell when said load demands a reduction in power output from the fuel cell; and
maintain the power output from the fuel cell at an initial level.

2. The protection circuit in accordance with claim 1, wherein said switch comprises an electromechanical contactor configured to be controlled by said controller.

3. The protection circuit in accordance with claim 1 further comprising a sensor coupled to the fuel cell and said controller, said sensor configured to detect a demanded power for the load.

4. The protection circuit in accordance with claim 1, wherein said controller is further coupled to the fuel cell, and wherein said controller is configured to control a chemical process by which the fuel cell generates the power output at the initial level.

5. The protection circuit in accordance with claim 4, wherein said controller is further configured to modify the chemical process to reduce the power output of the fuel cell after the auxiliary load is coupled to the fuel cell for a predetermined duration.

6. The protection circuit in accordance with claim 1, wherein said controller is further configured to decouple the auxiliary load from the fuel cell when the load subsequently demands an increase in the power output from the fuel cell.

7. The protection circuit in accordance with claim 1, wherein said controller is configured to:
compare the reduction in power demanded by the load to a predetermined ramp-rate limit for the fuel cell; and
close said switch to couple the auxiliary load when the reduction in power demanded exceeds the predetermined ramp-rate limit.

8. An electrical system comprising:
a fuel cell configured to generate an output power according to a chemical process;
an inverter coupled to said fuel cell, said inverter configured to couple said fuel cell to an electric load; and
a protection circuit coupled to said fuel cell and said inverter, said protection circuit configured to:
detect a reduction in the output power demanded by said inverter;
control an auxiliary load coupled to said fuel cell to utilize the output power at an initial level; and
maintain the power output from said fuel cell at the initial level.

9. The electrical system in accordance with claim 8, wherein said inverter is configured to convert a direct current (DC) power generated by said fuel cell to an AC power for the electric load.

10. The electrical system in accordance with claim 9, wherein said inverter is further configured to:
detect a transient event for the electric load; and
disconnect the electric load from said fuel cell in response to the transient event.

11. The electrical system in accordance with claim 8, wherein the auxiliary load comprises at least one of a resistive load bank, an electric heater, an electric steam generator, and a speed controlled blower.

12. The electrical system in accordance with claim 8, wherein said protection circuit comprises a controller configured to:
compare the reduction in the output power demanded by said inverter to a ramp-rate limit for said fuel cell and the chemical process; and
adjust a load set point of the auxiliary load to utilize the output power from said fuel cell when the reduction in the output power exceeds the ramp-rate limit.

13. The electrical system in accordance with claim 12, wherein said controller is further configured to modify the chemical process to reduce the output power when the reduction in the output power demanded by said inverter does not exceed the ramp-rate limit.

14. The electrical system in accordance with claim 8, wherein the auxiliary load comprises electrical equipment for controlling the chemical process by which said fuel cell generates the output power.

15. A method of controlling an output power of a fuel cell, said method comprising:
controlling a chemical process of the fuel cell to generate the output power at an initial level demanded by a load coupled to the fuel cell;
determining a reduction in power demanded by the load;
controlling an auxiliary load coupled to the fuel cell to utilize the reduction in power demanded by the load; and
maintaining the output power from the fuel cell at the initial level.

16. The method in accordance with claim 15 further comprising:
comparing the reduction in power demanded by the load to a ramp-rate limit for the fuel cell; and
coupling the auxiliary load to the fuel cell when the reduction in power demanded exceeds the ramp-rate limit.

17. The method in accordance with claim 15, wherein controlling the auxiliary load comprises adjusting a load set point of the auxiliary load.

18. The method in accordance with claim 15, wherein determining the reduction in power demanded by the load comprises detecting a disconnection of the load from the fuel cell in response to a transient event.

19. The method in accordance with claim 15 further comprising selecting the auxiliary load from among a plurality of auxiliary loads based on the reduction in power demanded by the load.

20. The method in accordance with claim 15 further comprising decoupling the auxiliary load when the load resumes power demanded at the initial level.

21. The method in accordance with claim 15, wherein determining the reduction in power demanded by the load comprises receiving a signal indicating a time and value of a planned reduction in power demanded by the load.

22. The method in accordance with claim 15 further comprising transmitting a feedback signal to the load indicating a capacity of the fuel cell to modify the output power generated.
